(19) United States
(12) Patent Application Publication
(10) Pub. No.: US 2025/0159267 A1
(43) Pub. Date: May 15, 2025

(54) VIDEO PROCESSING SYSTEM, COMPRESSION APPARATUS, VIDEO PROCESSING METHOD AND PROGRAM

(71) Applicant: NIPPON TELEGRAPH AND TELEPHONE CORPORATION, Tokyo (JP)

(72) Inventors: Hiroyuki KITADA, Tokyo (JP); Takafumi OKUYAMA, Tokyo (JP); Xiaotian ZHAO, Tokyo (JP)

(21) Appl. No.: 18/833,115

(22) PCT Filed: Jan. 27, 2022
(86) PCT No.: PCT/JP2022/003114

§ 371 Date: Jul. 25, 2024

(51) Int. Cl. H04N 21/2343

(52) U.S. Cl. CPC H04N 21/2343

(57) ABSTRACT

A video processing system includes a compression unit configured to individually compress and packetize a video signal for each of one or more first ranges that are targets of change in a video and one or more second ranges other than the first ranges, a video processing unit configured to execute a process for performing the change with packet groups related to the first ranges as processing targets, and a decoding unit configured to individually decode a packet group related to the first range and a packet group related to the second range among the packet groups processed by the video processing unit, and can thus change a part of a compressed video.

### TECHNICAL FIELD

The present invention relates to a video processing system, a compression apparatus, a video processing method, and a program.

### BACKGROUND ART

In live video distribution, services requiring ultra-low delay distribution have come out, but in a general video compression technology, not only a certain delay is generated, but also video composition overhead is generated.

In recent years, there is a protocol for transmitting an uncompressed video represented by ST2110 and a light compressed video close to an uncompressed video. Such a protocol has high affinity for video production, but requires many bands.

On the other hand, with the development of network technology, it is considered that a bit rate close to light compression will be able to be delivered to a user in the future. At that time, by applying a protocol such as ST2110 that has been closed and used for video production to video distribution, ultra-low delay distribution at end-to-end can be realized.

In recent years, a technology for replacing a video or the like by performing packet-based processing without decoding the video transmission protocol of ST2110 has also been proposed (Non Patent Literature 1). Many of such technologies target uncompressed videos, but processing in units of frames is also compatible with light compressed videos (Non Patent Literature 2).

### CITATION LIST

### Non Patent Literature

Non Patent Literature 1: Paul Briscoe, “Efficient Carriage of Sub-Rasters With ST 2110-20”
Non Patent Literature 2: Tetsuya Hayashida, “IP interface wo katsuyoshita 8K 60 Hz, 120 Hz konzai system no kontou”, NHK giken R & D 2020 nen, akigo hokoku 02, pp. 22 to 29 (in Japanese) (“Study on 8K 60 Hz and 120 Hz mixed system utilizing IP interface”, NHK STRL R & D 2020, autumn issue report 02, pp. 22 to 29)

### SUMMARY OF INVENTION

### Technical Problem

Since a compression process is performed in units of frames in a light compressed video, unlike an uncompressed video, when a partial packet of a frame is changed, the entire frame cannot be decoded, and the video is lost. Thus, the light compressed video can support switching in units of frames (video switching of the entire frame), but cannot support processes such as wiping, enlargement, and reduction that change a part of the frame.

Therefore, it is necessary to use an uncompressed video in a case of performing video processing in a frame, but it is difficult to apply the uncompressed video to a large-scale distribution because a lot of bands are consumed.

The present invention has been made in view of the above circumstances, and an object of the present invention is to enable a part of a compressed video to be changed.

### Solution to Problem

Therefore, in order to solve the above problem, a video processing system includes a compression unit configured to individually compress and packetize a video signal for each of one or more first ranges that are targets of change in a video and one or more second ranges other than the first ranges; a video processing unit configured to execute a process for performing the change with packet groups related to the first ranges as processing targets; and a decoding unit configured to individually decode a packet group related to the first range and a packet group related to the second range among the packet groups processed by the video processing unit.

### Advantageous Effects of Invention

It is possible to change a part of a compressed video.

### BRIEF DESCRIPTION OF DRAWINGS

FIG. 1 is a diagram illustrating a configuration example of a video processing system 1 according to a first embodiment.

FIG. 2 is a diagram illustrating a hardware configuration example of a compression device 10 according to the first embodiment.

FIG. 3 is a flowchart for describing an example of a processing procedure executed in the video processing system 1 according to the first embodiment.

FIG. 4 is a diagram for describing a specific example of a video source and video processing in the present embodiment.

FIG. 5 is a diagram illustrating an example of video source information.

FIG. 6 is a diagram illustrating an example of parameters configuring a control request.

FIG. 7 is a flowchart for describing an example of a processing procedure of a control algorithm.

FIG. 8 is a flowchart for describing an example of a processing procedure executed in a video processing system 1 of a second embodiment.

### DESCRIPTION OF EMBODIMENTS

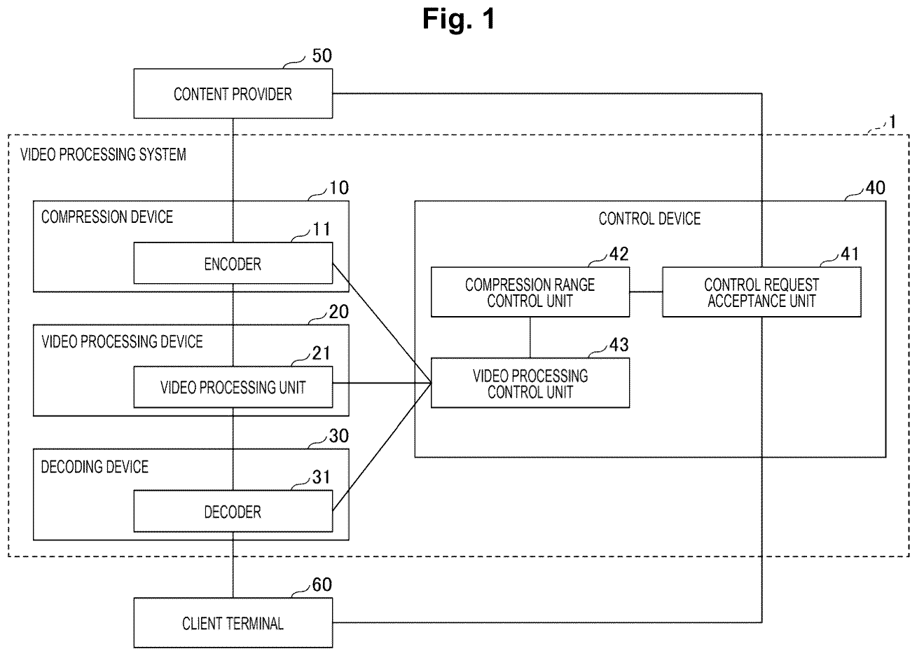

Hereinafter, embodiments of the present invention will be described with reference to the drawings. FIG. 1 is a diagram illustrating a configuration example of a video processing system 1 according to a first embodiment. In FIG. 1, the video processing system 1 includes a compression device 10, a video processing device 20, a decoding device 30, a control device 40, and the like. The compression device 10, the video processing device 20, the decoding device 30, and the control device 40 are, for example, computers belonging to a communication company. The compression device 10, the video processing device 20, and the decoding device 30 are connected to the control device 40 via a network in the communication company. The compression device 10 is further connected to the video processing device 20 via the network. The video processing device 20 is further connected to the decoding device 30 via the network. The control device 40 is further connected to a content provider 50 via the network. The content provider 50 is one or more computers that function as a supply source of a video source and a control request source regarding the video source. The supplied video source may be a live video or an archived video. In the case of a live video, a video source may be input to the control device 40 from a television camera or the like. The compression device 10 is further connected to the content provider 50 via a video transmission path such as HDMI (registered trademark) or SDI. A decoder 31 is further connected to a client terminal 60 such as a television terminal via a video transmission path such as HDMI (registered trademark) or SDI. The client terminal 60 is, for example, a television terminal used by a viewer of a video.

The compression device 10 includes an encoder 11. The encoder 11 is realized by a program installed in the compression device 10 causing a CPU of the compression device 10 to execute processes. The encoder 11 receives a video signal conforming to a standard such as HDMI (registered trademark) or SDI from the content provider 50. The encoder 11 performs light compression (hereinafter, simply referred to as “compression”) on a video indicated by the video signal, and converts the compressed video into an IP packet. Hereinafter, video information stored in the IP packet will be referred to as video data. The encoder 11 transmits an IP packet group including video data to the video processing device 20.

The video processing device 20 includes a video processing unit 21. The video processing unit 21 is realized by a program installed in the video processing device 20 causing a CPU of the video processing device 20 to execute processes. The video processing unit 21 executes video processing corresponding to video processing content reported from control device 40 on an IP packet group received from encoder 11. The video processing unit 21 transmits the IP packet group obtained as a result of the video processing to the decoding device 30. That is, the video processing unit 21 executes packet-based video processing.

The decoding device 30 includes a decoder 31. The decoder 31 is realized by a program installed in the decoding device 30 causing a CPU of the decoding device 30 to execute processes. The decoder 31 generates a video signal by decoding the light compressed video data stored in the IP packet group received from the video processing unit 21, and transmits the video signal to the client terminal 60.

The control device 40 includes a control request acceptance unit 41, a compression range control unit 42, and a video processing control unit 43. These units are realized by one or more programs installed in the control device 40 causing a CPU of the control device 40 to execute processes.

The control request acceptance unit 41 accepts a control request for a video source from the content provider 50 or the client terminal 60. The control request is a request related to reduction of the video, change of a part of the video, and the like.

The compression range control unit 42 determines a layout of a compression range of the video source on the basis of the control request, and notifies the encoder 11 and the decoder 31 of information indicating the layout (hereinafter, referred to as “layout information”). The compression range is a division range that is a processing target in one compression. The compression range control unit 42 determines each of one or more ranges (ranges in a video frame) that are change targets in the video processing and one or more ranges (ranges in the video frame) other than the one or more ranges as one compression range (that is, each range is individually compressed and packetized). The encoder 11 individually performs compression and packetization for each compression range.

The video processing control unit 43 determines video processing content on the basis of the control request. The video processing control unit 43 notifies the encoder 11, the video processing unit 21, and the decoder 31 of control information including the compression range determined by the compression range control unit 42, the video processing content, and the like.

Note that a plurality of encoders 11, a plurality of video processing units 21, and a plurality of decoders 31 are provided, and are installed in appropriate places (for example, places where the cost is low) or those installed in appropriate places are used, according to a position of the content provider 50 or a position of the client terminal 60. On the other hand, when viewed from the video source, the encoder 11 is any one, and the decoder 31 is any one for each client terminal 60. It is also conceivable that video data transmitted from one encoder 11 is delivered to a plurality of client terminals 60 via a plurality of video processing units 21 and a plurality of decoders 31 according to a technique such as multicasting. The decoder 31 may be disposed in the same place (inside home or the like) as the client terminal 60 instead of the network of the network operator. In this case, the decoder 31 may be arranged in a set top box (STB), the client terminal 60, or the like.

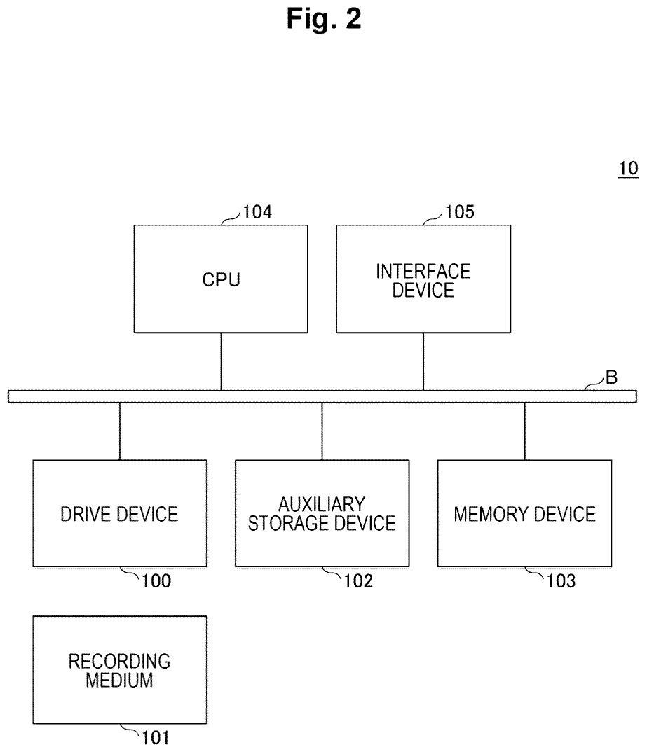

FIG. 2 is a diagram illustrating a hardware configuration example of the compression device 10 according to the first embodiment. The compression device 10 in FIG. 2 includes a drive device 100, an auxiliary storage device 102, a memory device 103, a CPU 104, an interface device 105, and the like which are connected to each other via a bus B.

A program for realizing processing in the compression device 10 is provided by a recording medium 101 such as a CD-ROM. When the recording medium 101 storing the program is set in the drive device 100, the program is installed on the auxiliary storage device 102 from the recording medium 101 via the drive device 100. Here, the program is not necessarily installed from the recording medium 101 and may be downloaded from another computer via a network. The auxiliary storage device 102 stores the installed program and also stores necessary files, data, and the like.

In a case where there is an instruction to start the program, the memory device 103 reads the program from the auxiliary storage device 102 and stores the program. The CPU 104 executes a function related to the compression device 10 according to the program stored in the memory device 103. The interface device 105 is used as an interface for connection to a network.

Note that the video processing device 20, the decoding device 30, and the control device 40 also have a hardware configuration similar to that in FIG. 2.

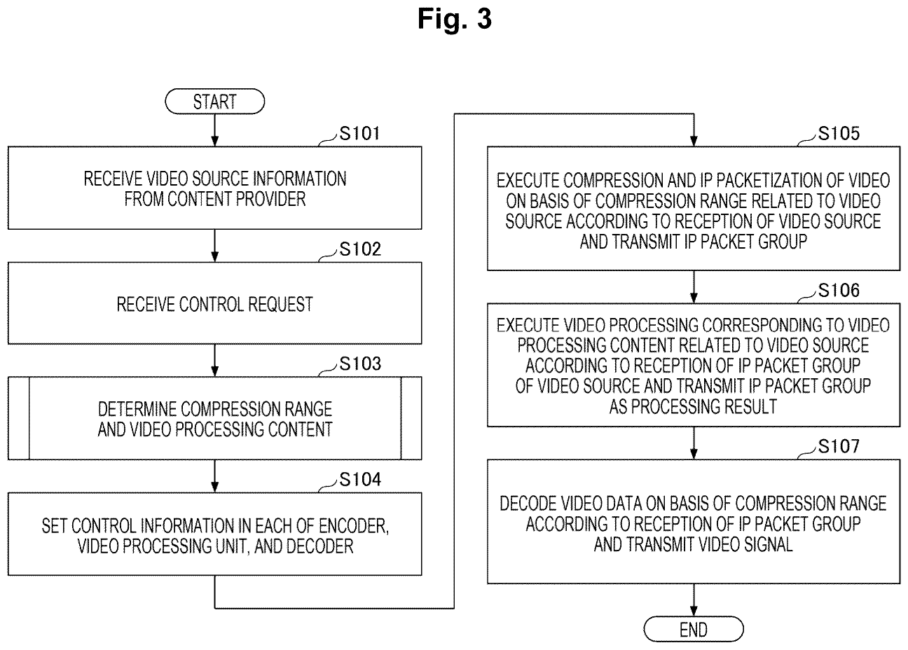

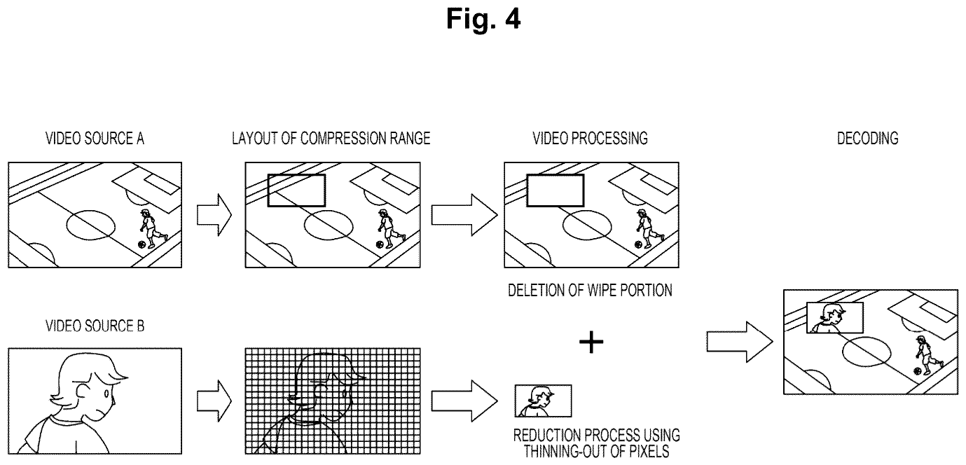

Hereinafter, a processing procedure executed in the video processing system 1 will be described. FIG. 3 is a flowchart for describing an example of a processing procedure executed in the video processing system 1 in the first embodiment. Here, it is assumed that the content provider 50 starts distributing video sources A and B in the leftmost column in FIG. 4.

In step S101, the control request acceptance unit 41 of the control device 40 receives video source information from the content provider 50, and registers the video source information in a database. The database is implemented by using, for example, the auxiliary storage device 102.

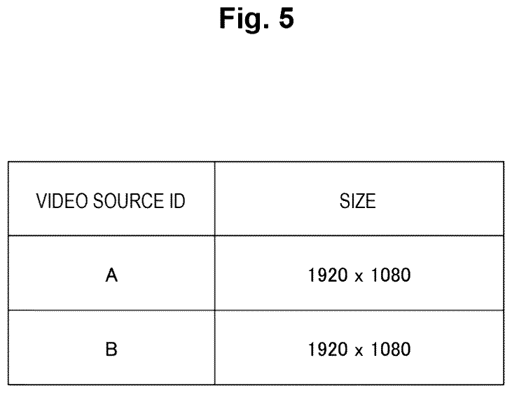

FIG. 5 is a diagram illustrating an example of video source information. As illustrated in FIG. 5, the video source information includes a video source ID and a size. The video source ID is identification information of the video source. The size is the number of pixels in a horizontal direction and a height direction of the video source. Note that, in order to correspond to the specific example in FIG. 4, video source information of each of video source A and video source B is received.

Note that the processing procedure of FIG. 3 is started with step S101 as a trigger. When a video source is added (for example, the number of cameras increases in the middle of a program) or a new control request is generated, the processing procedure in FIG. 3 is executed again.

Subsequently, upon receiving a control request from the content provider 50 or the client terminal 60, the control request acceptance unit 41 registers the control request in the database (S102).

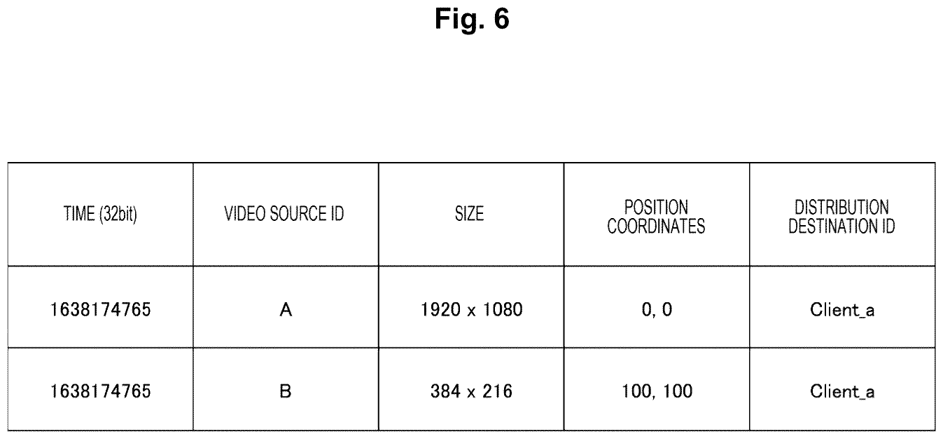

FIG. 6 is a diagram illustrating an example of parameters configuring a control request. FIG. 6 illustrates two control requests: a control request related to the video source A and a control request related to the video source B. Each control request includes a time, a video source ID, a size, position coordinates, a distribution destination ID, and the like. The time is a time at which control based on the control request is started. The video source ID is a video source ID of a video source that is a target of the control request. The size is a size of a video frame after video processing is applied according to the control request. That is, the size indicates that the video processing is to be performed such that the video frame has the size. The position coordinates are position coordinates of a video frame after the video processing is applied according to the control request. That is, the position coordinates indicate that the video processing is to be performed such that an upper left vertex of the video frame is disposed at a position indicated by the position coordinates. The distribution destination ID is identification information (an IP address or the like) of the client terminal 60 that is a distribution destination of the video signal after the video processing is executed according to the control request. Note that the distribution destination ID of the control request transmitted from the client terminal 60 is basically identification information of the client terminal 60. For example, in a case where a viewer inputs a video editing instruction to the client terminal 60, a control request corresponding to the editing instruction and having the identification information of the client terminal 60 as the distribution destination ID is transmitted from the client terminal 60. On the other hand, the distribution destination ID of the control request transmitted from the content provider 50 is designated by a director or the like of a program. For example, identification information of all distribution destinations (client terminals 60) may be designated as distribution destination IDs, or identification information of a specific client terminal 60 may be designated as a distribution destination ID.

Subsequently, the control device 40 inputs the information (the video source information (FIG. 5) and the control request (FIG. 6)) stored in the database to a control algorithm, and determines a layout of compression range and video processing content for each video source (S103). The control algorithm will be described later.

In the present embodiment, as shown in the column of “layout of compression range” in FIG. 4, for the video source A, a compression range is divided into a range in which the video source B is wiped and the range other than that. On the other hand, since the video source B needs to be reduced to fall within the wipe range, the compression range is divided into each range thinned out for reduction and each range not thinned out. As the video processing content related to the video source A, a process for enabling combination of the reduced video source B with respect to an IP packet group belonging to the range in which the video source B is wiped, among IP packet groups that are encoding results of the video source A, is determined. As the video processing content related to the video source B, a process necessary for reducing the video source B with respect to an IP packet group that is an encoding result of the video source B is determined. That is, in the present embodiment, the video processing is executed at a packet level. Specific examples of layout information and video processing content of the compression range determined for each of the video source A and the video source B will be described below.

### [Layout of Compression Range and Video Processing Content for Video Source A]

Layout of compression range: The compression range is divided into a range (pixel group) of a position (100, 100) and a size of 384×216 and the range other than that (pixel group).

Video processing content: Header information of each IP packet corresponding to a pixel belonging to the range of the position (100, 100) and the size of 384×216 is copied to a header of an IP packet of the video source B (an IP packet to which the following video processing content is applied) that replaces the IP packet, and the IP packet group of the video source A in the range is discarded.

### [Layout of Compression Range and Video Processing Content for Video Source B]

Layout of compression range: Divided into 160×180 (horizontal 12×vertical 6 pixels per range)

Video processing content: A part of a video is thinned out (a part of a packet is discarded) at regular intervals from 160 to 32 in the horizontal direction and from 180 to 36 in the vertical direction, and the header information of the video source A is copied to the header of the remaining IP packet. Note that the video of the video source B is reduced through the thinning-out.

Subsequently, the video processing control unit 43 of the control device 40 sets necessary control information in each of the encoder 11, the video processing unit 21, and the decoder 31 (S104). In the encoder 11, a video source ID, layout information of a compression range, a control start time, and a distribution destination ID are set as the control information for each video source. In the video processing unit 21, a video source ID, video processing content, and a control start time are set as the control information for each video source. In the decoder 31, a video source ID, layout information of a compression range, and a control start time are set as the control information for each video source.

The layout information of the compression range and the video processing content are values determined in step S103. The control start time and the distribution destination ID are a time and a distribution destination ID included in the control request.

Subsequently, upon receiving the video signals of the video sources A and B from the content provider 50, for each video source, when the control start time set together with the video source ID of the video source has elapsed, the encoder 11 performs video compression and IP packetization on the basis of the video source ID and the layout information of the compression range set together with the control start time, and transmits an IP packet group (video data) to the video processing unit 21 (S105). As described above, the encoder 11 individually performs the compression process on the video frame of each video source for each compression range for the video source ID. The encoder 11 individually performs IP packetization for each compression range. Therefore, pixels belonging to different compression ranges are not included in the same IP packet.

Note that, according to ST2110, time information of the current time is stored in a header portion of an RTP packet, and pixel (color) information in the video frame, a video source ID, an identification number of the video frame, and position information of a pixel in the video frame are stored in a payload portion. For example, in ST2110, an RTP header is used, and time information is included as a time stamp value. The distribution destination ID set together with the video source ID is set for a destination IP address of each IP packet.

Subsequently, upon receiving the IP packet group (video data) of each video source transmitted from the encoder 11, for each video source, when the time information of the IP packet group related to the video source has passed the control start time set together with the video source ID of the video source and the distribution destination ID of the IP packet group, the video processing unit 21 executes the video processing according to the video processing content set together with the video source ID and the distribution destination ID, and transmits the IP packet group (video data) after the video processing to the decoder 31 (S106).

According to the example of the video processing content described above, in the present embodiment, for the video source A, the video processing unit 21 copies the header information of each IP packet corresponding to pixels belonging to the range of the position (100, 100) and the size of 384×216 to the header of the IP packet of the video source B (the IP packet to which the following video processing content is applied) that replaces the IP packet, and discards the IP packet group of the video source A in the range. The video processing unit 21 thins out the video source B (discards a packet) from 160 to 32 in the horizontal direction and from 180 to 36 in the vertical direction, and copies the header information of the video source A to the header of a remaining IP packet.

As a result of the video processing, as shown in the column of “video processing” in FIG. 4, for the video source A, the video data (IP packet group) from which the wipe portion has been deleted (the packet including the pixels of the portion has been discarded) is transmitted to the decoder 31, and for the video source B, the reduced (thinned-out) video data (IP packet group) is transmitted to the decoder 31. However, since the header information of the video source A is copied to the header of the IP packet group related to the video source B, the IP packet group transmitted to the decoder 31 is the IP packet group related to the video source A.

Subsequently, upon receiving the IP packet group (video data) after the video processing transmitted from the encoder 11, when the time information of the IP packet group has passed the control start time set together with the video source ID of the IP packet group and the distribution destination ID of the IP packet group, the decoder 31 generates a video signal by decoding the video data on the basis of the layout information of the compression range set together with the video source ID and the distribution destination ID, and transmits the video signal to the client terminal 60 related to the distribution destination ID (S107). At the time of decoding, for each compression range, the decoder 31 extracts the video data from the IP packet group belonging to the compression range, and collectively decodes the extracted video data group. That is, the decoder 31 performs decoding individually (separately) for each range compressed by the encoder 11. Consequently, a video signal can be correctly generated.

As a result, as shown in the column of “decoding” in FIG. 4, the video signal including the reduced video source B in the upper left wipe portion of the video source A is transmitted to the client terminal 60.

Note that transmission from the decoder 31 may be performed according to uncompressed ST2110 (an IP packet group including a decoded video), SDI, or HDMI (registered trademark).

In transmission of video data from the decoder 31 (compression device 10) to the video processing unit 21 (video processing device 20) and transmission of video data from the video processing unit 21 (video processing device 20) to the decoder 31 (decoding device 30), specific destination information may be an IP address or a device ID.

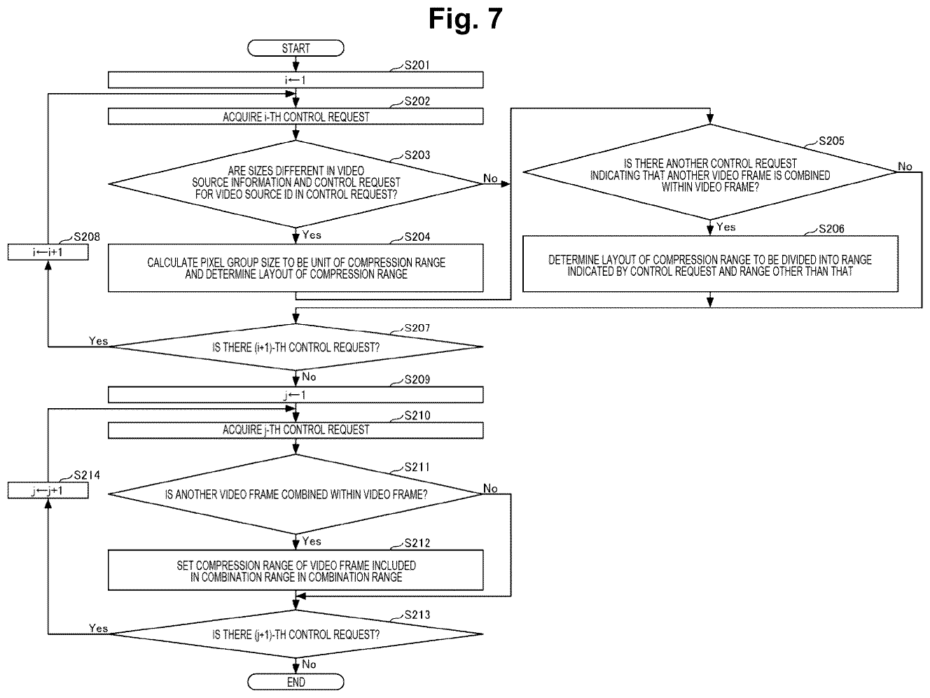

Next, details of step S103 will be described. FIG. 7 is a flowchart for describing an example of the processing procedure executed by the control algorithm.

In step S201, the compression range control unit 42 assigns 1 to a variable i. The variable i is a variable for storing the order of the control requests that are processing targets.

Subsequently, the compression range control unit 42 acquires an i-th control request (S202). For example, according to the example in FIG. 6, the control request in the first row is acquired. Hereinafter, the acquired control request will be referred to as a “target control request”.

Subsequently, the compression range control unit 42 determines whether the size in the video source information and the size in the target control request are different for the video source ID in the target control request (S203). Both of the sizes are the same for the first control request in FIG. 6, but both of the sizes are different for the second control request.

In a case where the size in the video source information is different from the size in the target control request (Yes in S203), the compression range control unit 42 calculates a pixel group size to be a unit of a compression range, sets each pixel group as one compression range, and determines disposition information of the compression range as a layout of the compression range (S204). That is, in step S204, each of small tiles (pixel groups) formed by being divided in the vertical and horizontal directions of the video frame as in the example of “layout of compression range” of the video source B in FIG. 4 is set as one compression range such that the video processing unit 21 can perform packet thinning (pixel deletion) on the video frame that requires a reduction process.

For example, when the full HD (1920×1080) is divided in units of pixel groups of horizontal 12×vertical 6, the full HD is divided into 160×180, and each one becomes a compression range. In this case, the video processing unit 21 can reduce the video to 960×540 by discarding the packets corresponding to even-numbered packets in the vertical and horizontal directions.

Specifically, the compression range control unit 42 determines the compression range through the following calculations (1) to (3).

(1) A common divisor of the size in the video source information and the size in the control request is calculated for each of the vertical and horizontal directions.

(2) For each of the vertical and horizontal directions, any one value is selected from among calculated one or more common divisors. The smaller the value, the finer the unit, and the higher the video quality but the lower the compression efficiency. Which value to select may be set as one of parameters of the control request, or may be reported to the control device 40 by using another method.

(3) Each pixel group related to a rectangular range formed by a value selected for each of the vertical and horizontal directions is set as one compression range, and a layout of the compression range is determined.

Note that, in step S204, the video processing control unit 43 determines content of processing required to reduce the video source B (video processing content for the video source B in the present embodiment) for the IP packet group that is an encoding result of the video source corresponding to the target control request (hereinafter, referred to as a “target video source”) as video processing content for the target video source.

In a case of No in step S203 or following step S204, the compression range control unit 42 determines the presence or absence of another control request indicating that another video frame is combined (wiped) within the video frame of the video source related to the video source ID in the target control request (S205). Specifically, the compression range control unit 42 determines whether there is a control request in which a size value is smaller than a size value in the target control request.

When there are one or more corresponding control requests (hereinafter, a “corresponding control request”) (Yes in S205), the compression range control unit 42 determines a layout of the compression range such that each of a range (that is, a range in which another video is combined) indicated by the position and the size in the corresponding control request and a range other than the range is divided as one compression range in the video frame of the target video source (S206). That is, in step S204, the layout of the compression range is determined in order to enable a reduction process (thinning-out), but in step S206, the compression range is divided such that a portion where rewriting (change) occurs and a portion where rewriting does not occur in the video frame can be independently decoded. Consequently, even if a part of the video frame is rewritten, the video can normally be decoded.

In a case where there are a plurality of corresponding control requests, that is, in a case where a plurality of video frames are combined with the video frame of the target video source, the overlapping order of the plurality of video frames may be considered. For example, a parameter indicating the overlapping order may be set in each control request, or the overlapping order may be determined on the basis of the order of the control requests.

Note that, in step S206, video processing control unit 43 determines, as the video processing content for the target video source, content of processing (the video processing content for the video source A in the present embodiment) for enabling combination of another video source with respect to an IP packet group belonging to a range in which the video source corresponding to the control request is wiped, among IP packet groups that are encoding results of the target video source.

In the case of No in step S205 or following step S206, the compression range control unit 42 determines the presence or absence of an (i+1)-th control request (S207). In a case where the (i+1)-th control request is present (Yes in S207), the compression range control unit 42 adds 1 to i (S208), and repeatedly performs step S202 and the subsequent steps. In a case where there is no (i+1)-th control request (No in S207), the compression range control unit 42 assigns 1 to a variable j (S209). The variable j is a variable for storing the order of the control requests that are processing targets.

Subsequently, the compression range control unit 42 acquires a j-th control request (S210). Hereinafter, the acquired control request will be referred to as a “target control request”.

Subsequently, the compression range control unit 42 determines whether or not a video frame (hereinafter, referred to “another video frame”) of another video source is combined within a video frame (hereinafter, referred to as a “target image frame”) of the video related to the video source ID of the target control request (S211). Such determination may be performed on the basis of the same determination as in step S205. Alternatively, it may be determined in step S205 whether a determination result is Yes or No.

In a case where the other video frame is combined within the target video frame (Yes in S211), the compression range control unit 42 sets layout information of a compression range of the other video frame for a range (hereinafter, referred to as a “combination range”) in which the other video frame is combined in the target video frame (S212). In other words, the compression range control unit 42 replaces the layout of the compression range in the combination range with the layout of the compression range of the other video frame. In the present embodiment, in the video frame of video source A, the layout of the compression range in the range in which the video frame of video source B is combined is a layout of the compression range determined for the video source B. Consequently, in step S107 described above, the decoder 31 can also correctly decode the combination range (for each compression range determined for the video source B) on the basis of only the compression range corresponding to the video source A.

In the case of No in step S211 or following step S212, the compression range control unit 42 determines the presence or absence of a (j+1)-th control request (S213). In a case where the (j+1)-th control request is present (Yes in S213), the compression range control unit 42 adds 1 to j (S214), and repeatedly performs step S202 and the subsequent steps. In a case where there is no (j+1)-th control request (No in S213), the compression range control unit 42 ends the processing procedure in FIG. 7.

As described above, according to the first embodiment, the entire video frame is not set as one compression range, but the compression range is divided according to video processing required for the video, compression (encoding) is performed for each compression range, and IP packetization is performed within the compression range. As a result, in the video processing in a state of an IP packet, the video processing can be performed not to destroy the compression range. Therefore, it is possible to change a part of a compressed video.

Since a part of the compressed video can be changed, it is possible to perform video processing with low delay and a smaller number of bands than in an uncompressed video and distribute the video as compared with video processing that requires conventional video decoding.

Next, a second embodiment will be described. In the second embodiment, differences from the first embodiment will be described. Details not specifically mentioned in the second embodiment may be the same as those in the first embodiment.

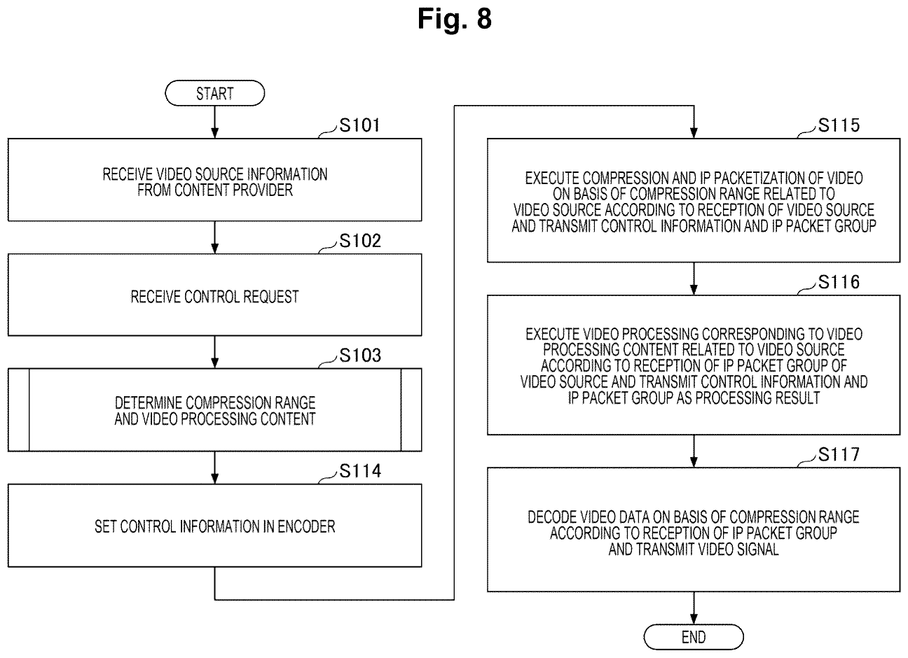

FIG. 8 is a flowchart for describing an example of a processing procedure executed in the video processing system 1 in the second embodiment. In FIG. 8, the same steps as those in FIG. 3 are denoted by the same step numbers, and the description thereof will be omitted.

Following step S103, the video processing control unit 43 sets control information including a video source ID, layout information of a compression range, a control start time, and a distribution destination ID for each video source, in each of the encoder 11, the video processing unit 21, and the decoder 31 (S114).

Subsequently, the encoder 11 executes a process basically similar to that in step S105 in FIG. 3 (S115). However, the encoder 11 transmits the control information to the video processing unit 21, and subsequently transmits an IP packet group to the video processing unit 21.

Subsequently, upon receiving the control information transmitted from the encoder 11, the video processing unit 21 stores the control information and transmits the control information to the decoder 31, and upon receiving the IP packet group (video data) of each video source transmitted from the encoder 11, the video processing unit 21 executes a process similar to that in step S106 in FIG. 3 on the basis of the stored control information (S116).

Subsequently, upon receiving the control information transmitted from the video processing unit 21, the decoder 31 stores the control information, and upon receiving the IP packet group (video data) of each video source transmitted from the video processing unit 21, the decoder 31 executes a process similar to that in step S107 in FIG. 3 on the basis of the stored control information (S117).

That is, in the second embodiment, the control information is transmitted to the encoder 11, the video processing unit 21, and the decoder 31. Even in such a mode, the same effects as those of the first embodiment can be achieved.

Note that, in each of the above embodiments, the encoder 11 is an example of a compression unit. The decoder 31 is an example of a decoding unit.

Although the embodiments of the present invention have been described in detail above, the present invention is not limited to such specific embodiments, and various modifications and changes can be made within the scope of the gist of the present invention described in the claims.

### REFERENCE SIGNS LIST

1 Video processing system
10 Compression device
11 Encoder
20 Video processing device
21 Video processing unit
30 Decoding device
31 Decoder
40 Control device
41 Control request acceptance unit
42 Compression range control unit
43 Video processing control unit
50 Content provider
60 Client terminal
100 Drive device
101 Recording medium
102 Auxiliary storage device
103 Memory device
104 CPU
105 Interface device
B Bus

1. A video processing system comprising:
circuitry configured to
individually compress and packetize a video signal for each of (i) one or more first ranges to be changed in a video and (ii) one or more second ranges other than the first ranges;
execute a process of making a change in packet groups related to the first ranges to be processed; and
individually decode a first packet group related to a given first range, and a second packet group related to a given second range, among processed packet groups.

2. The video processing system according to claim 1, wherein the change includes thinning out a part of the video at regular intervals to reduce a size of the video, the given first range being a range in which the part of the video is to be thinned out, and
wherein the circuitry is configured to discard a packet in the given first range.

3. The video processing system according to claim 1, wherein the change includes a change in a partial range of the video, the given first range being the partial range, and
wherein the circuitry is configured to change a packet in the given first range.

4. A compression apparatus comprising:
circuitry configured to individually compress and packetize a video signal for each of (i) one or more first ranges to be changed in a video and (ii) one or more second ranges other than the first ranges.

5. A video processing method executed by a computer, comprising:
individually compressing and packetizing a video signal for each of (i) one or more first ranges to be changed in a video and (ii) one or more second ranges other than the first ranges;
executing a process of making a change in packet groups related to the first ranges to be processed; and
individually decoding a first packet group related to a given first range, and a second packet group related to a given second range, among processed packet groups.

6. A non-transitory computer readable storage medium storing a program causing a computer to execute the video processing method of claim 5.
